(19) United States
(12) Patent Application Publication
(10) Pub. No.: US 2026/0049197 A1
(43) Pub. Date: Feb. 19, 2026

(54) SYSTEMS AND METHODS OF PLASMA ASSISTED OXIDATIVE DEPOLYMERIZATION OF POLYMERS AND PRODUCTION OF BIODEGRADABLE POLYMERS

(71) Applicant: UNIVERSITY OF LOUISVILLE RESEARCH FOUNDATION, INC., Louisville, KY (US)

(72) Inventors: Noppadon SATHITSUKSANOH, Louisville, KY (US); Mohammad Shahinur RAHAMAN, Louisville, KY (US)

(73) Assignee: UNIVERSITY OF LOUISVILLE RESEARCH FOUNDATION, INC., Louisville, KY (US)

(21) Appl. No.: 19/102,892

(22) PCT Filed: Aug. 18, 2023
(86) PCT No.: PCT/US2023/030580

§ 371 Date: Feb. 11, 2025

Related U.S. Application Data
(60) Provisional application No. 63/399,254, filed on Aug. 19, 2022.

(51) Int. Cl. C08J 11/28; C08J 11/10; C08J 11/14

(52) U.S. Cl. CPC C08J 11/28; C08J 11/105; C08J 11/14; C08J 2300/16

(57) ABSTRACT

A plasma-assisted method includes receiving pieces of waste polymer, then applying a modification process that weakens the waste polymer covalent bonds. A low temperature oxidative depolymerization process is applied to the modified polymer, which transforms the modified polymer to a short chain polymer. Optionally the short chain polymer includes C2-C2. Optionally the short chain polymer is input to a process of bacteria metabolization that produces medium-chain-length poly hydroxyalkanoates (mcl-PHAs). Optionally the bacteria is a Pseudomonas strain. Optionally the oxidative depolymerization process is performed at room temperature.

### CROSS REFERENCE TO RELATED APPLICATIONS

This application claims the benefit of U.S. Provisional Application No. 63/399,254 filed Aug. 19, 2022.

### STATEMENT REGARDING FEDERALLY SPONSORED RESEARCH OR DEVELOPMENT

This invention was made with government support under grant number 2145312 awarded by the National Science Foundation. The government has certain rights in the invention.

### BACKGROUND

### Technical Field

The following relates generally to recycling and upcycling waste plastic, and more specifically to depolymerization of waste plastics.

### State of Technology

Notwithstanding decades of widespread efforts by various governmental authorities, businesses, large and small, profit based and not for profit, less than 10% of plastic and other polymer waste is recycled. The other 90% is distributed within, e.g., dumped into the environment and every year the amount continues to increase. In 2016, plastics waste per capita was 287 pounds.

There are a number of reasons. Significant among these are various technical shortcomings of current techniques of recycling polymer waste. The shortcomings impose many costs, direct and secondary. The costs include the quality of materials the recycling produces. Inferior quality recovered product creates inferior quality end products, i.e., becomes “downcycling.” The downcycling reduces the demand for end products made from the recycling produced material. The reduced demand discourages recycling by the waste management industry. The result: most polymer waste (more than approximately 70%) is tucked away in landfills, slowly degrading into microparticles that leak into waterways, contaminate agriculture, and negatively affect health.

Pyrolysis is a technique that can accommodate a large amount of polymer. However, current pyrolysis techniques have significant shortcomings. One is the requirement of high temperature (>300-900° C.), which in turn can cause generation of hazardous greenhouse gases (methane, carbon dioxide) from the burning of fossil fuels to reach high temperatures.

### SUMMARY

Systems and methods according to disclosed embodiments can enable substantially improved methods for recycling waste polymers. Features and benefits include, without limitation, energy-efficiency, and transformation of the waste polymer into valuable chemicals and other products.

Methods according to one or more embodiments can include a novel oxidative depolymerization process. As will be appreciated by persons of ordinary skill in the pertinent arts upon reading this disclosure, this oxidative depolymerization process can have significant stand-alone value. These include, without limitation, the oxidative depolymerization process being configurable to produce, as the transformation output, organic acids that are readily transformable by bacteria into further processable products. For example, according to various embodiments, the organic acids can be ones that can be consumed and metabolized by certain bacteria to produce medium chain length C6-C14 polyhydroxyalkanoates (mcl-PHAs).

According to various embodiments, the Mcl-PHAs can be used to prepare non-fossil fuel-based plastics. The mcl-PHAs can replace, for example, any of, multiple ones of, or all of PE, PP. PS, and PET. The ability to produce these materials under mild conditions provides environmental and economic advantages with respect to plastic recycling and upcycling.

Also, plasma-assisted oxidative depolymerization of polymers in accordance with various embodiments, by enabling conversion at far lower temperature, can provide drastic reduction in energy consumption. This provides a range of further benefits including feasibility to power the recycling via renewable electricity from solar and wind.

Additional features are set forth in the description that follows, and in part will be apparent from the description or may be learned by practice of the described techniques.

Examples of the described techniques include, but are not limited to a method for transforming organic polymer waste, which can include comprising chemically functionalizing waste pieces of organic polymer, having respective surfaces, into pieces of sulfonated organic polymer having respective sulfonated polymer surfaces, one or more of the sulfonated polymer surfaces supporting sulfonate moieties, and oxidatively depolymerizing one or more of the pieces of sulfonated organic polymer, in an electric field, into a depolymerization product comprising a plurality of acids.

Examples further include, without limitation, a fermenting of the depolymerization product into medium-chain-length polyhydroxyalkanoates (mcl-PHAs).

### DESCRIPTION OF THE DRAWINGS

FIG. 1 shows a block schematic of one example flow of operations in one example process according to one or more embodiments, providing low heat, low power consumption transformation of organic polymer waste from a starting state of being an inert organic polymer to a significantly higher value state as a reactive oxygen species (ROS).

FIG. 2 shows an image of one example plasma chamber with an example anode and cathode, carrying one liquid (e.g., water) phase and a gas phase to initiate oxidative depolymerization reactions in accordance with one or more embodiments.

FIG. 3 shows another perspective of the FIG. 2 example plasma chamber juxtaposed with a graphic model of a phase=liquid phase interface.

FIG. 4 shows synergy between functionalization and plasma oxidation of polypropylene (PP), and PP-SO3H being hydrophilic.

FIG. 5 shows synergy between polymer functionalization and plasma oxidation using UiO-66 catalysts enabled the formation of 43.5 wt. % organic acids at 50 wt. % conversion (thermal=60° C., plasma=5 kV input voltage and 20-50 kHz for 4 h).

FIG. 6 shows a block schematic of one example flow of operations in one example process according to one or more other embodiments, utilizing the low heat, low power transformation of organic polymer waste to ROS, combined with biological transformation according to one or more embodiments of the ROS into mcl-PHAs.

FIGS. 7A, 7B, and 7C show three temporally spaced snapshots of a first magnification of a transmission electron microscopy (TEM) captured image of accumulation of PHAs (medium chain length polyhydroxyalkanoates, C6-C14) in the P. putida KT2440 (bright granules=PHAs).

FIGS. 8A, 8B, and 8C show three temporally spaced snapshots of a second magnification TEM captured image of the accumulation of PHAs in the P. putida KT2440.

FIG. 9 shows a diagrammatic model of metabolic pathways of selected organic acids by P. putida.

FIG. 10A, FIG. 10B, and FIG. 10C show acid mixture affecting cell growth and PHA yield.

FIG. 11 shows a plasma-mediated oxidative depolymerization of sulfonated polypropylene and polyethylene.

FIG. 12 shows effects of radical species on plasma-mediated oxidative depolymerization of sulfonated polypropylene and polyethylene.

FIG. 13 shows plasma-mediated depolymerization of modified polypropylene (PP-SO3H).

FIG. 14 shows an analysis based indication of potential increase in recycling rates and potential decrease in the amount of plastic added to landfilled that may result from analysis based incentives provided by one or more embodiments.

FIG. 15 shows a flow diagram of one example process in accordance with various embodiments for converting non-limiting examples of plastics often characterized as non-recyclable #3-7 into mcl-PHAs.

### DETAILED DESCRIPTION

Described techniques are directed to improved systems and methods for treating polymer waste, which can provide not only removal of the waste but also conversion of the waste into higher value products. Embodiments include combinations of novel steps that can further provide reduction in power consumption, and substantial reduction in environmental impact.

It is known that plasmas can form excited plasma species that, in turn, can drive certain chemical reactions with water molecules that can generate reactive oxygen species (ROS) such as hydroxyl radicals (OH·), superoxide (O₂⁻), and H₂O₂. These ROS initiate oxidative depolymerization reactions, which can be used for the decomposition of organic compounds in water.

However it is also known that such plasma techniques have a plurality of shortcomings. The shortcomings militate against large scale use. One such shortcoming is its use of homogenous catalysts, for example Fe(II), which can contaminate products made from the technique's output. Another shortcoming is its need to stay within a narrow pH window (for example, pH values of 2.7-3.5) to maintain oxidation activity. Still another shortcoming is a tendency of over-oxidation of products, producing CO₂. This is a highly undesirable outcome, given current climate changes ascribed to excess CO₂. These limitations make this process difficult and impractical to apply on a large scale.

Techniques in accordance with one or more disclosed embodiments, in contrast, can be at room temperature, i.e., are energy-efficient, and can transform petroleum-derived plastics into carboxylates and, via subsequent fermentation, can transform the carboxylate into biodegradable plastics, namely, mcl-PHAs. The mcl-PHAs, based at least in part on being biodegradable, can have multiple forms of high value, respectively usable and exploitable at different times, by a number of different entities and interests.

An example instance of a process can include an introducing, e.g., a transferring a quantity of recyclable plastics into, for example, a vat or other container that can be filled with a solvent. For purposes of description, the subject batch or quantity of recyclable plastic will be alternatively referenced as “the recycling batch” and “the recyclable plastic content of the recycling batch.”

According to one or embodiments, the process can proceed to a particular modifying of surfaces of the recyclable polymer in the recycling batch. The modifying can comprise reacting, in a suitable solvent, the waste polymer with a modifying agent that adds at least type of polar groups to the plastic. The added polar chemical groups can provide a weakening of the C—C bonds in the polymer. Processes according to various embodiments employ this weakening for further functions and processes, including a low temperature plasma oxidation depolymerization process. The added polar chemical group can also improve wettability for reaction in water.

A result of the modification process can be a solvent stream comprising the solvent and solid modified polymer. The solid modified polymer can be separated from the solvent stream and placed in a chamber having a partial fill or other reservoir of a liquid, e.g., water. The liquid surface can then be exposed to an electrical discharge generated between metal electrodes, which creates a plasma. Exposure of the modified polymer to the plasma results in the cleavage of the plastic's C—C bonds and the formation of C2-C4 carboxylates.

According to one or more embodiments, the resulting depolymerization products (carboxylates) can be consumed and metabolized by a suitable bacterium. The metabolization can produce, for example, mcl-PHAs.

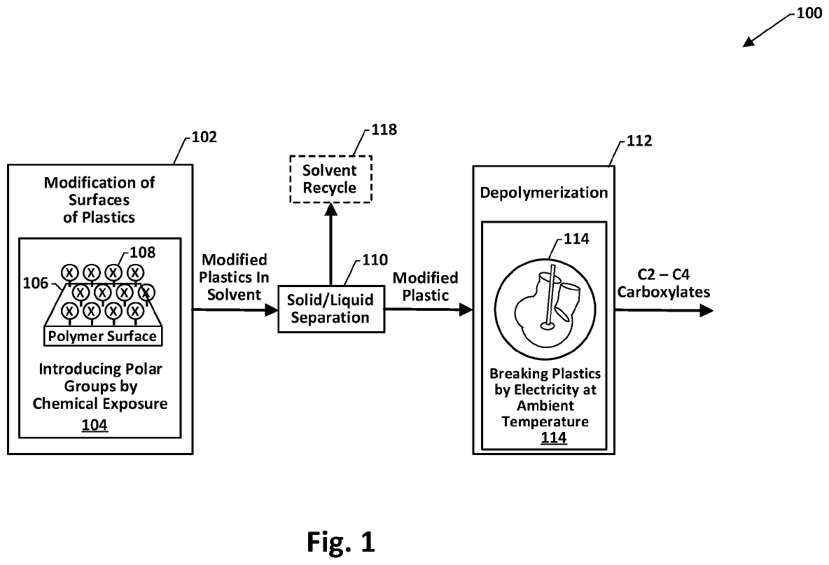

FIG. 1 shows a block schematic of one example flow 100 of operations in one example process according to one or more embodiments. Features of the process include, without limitation, providing low heat, low power consumption transformation of organic polymer waste from a starting state of being an inert organic polymer to a significantly higher value state as an ROS.

An example process according to the flow 100 can include receiving a batch of polymer waste material, e.g., as mechanically separated or shredded pieces and then, according to various embodiments applying a particular modification process 102 that effectuates a weakening of the C—C covalent bonds in the polymer. The weakening of the C—C covalent bonds, in accordance with various embodiments, renders the subject polymer amenable to cleavage as described in more detail in subsequent paragraphs.

According to one or more embodiments, operations in the modification process 102 for effectuating the weakening of the C—C covalent bonds can comprise a process 104 introducing polar groups by chemical exposure. The process 104 can include, for example, chemical exposure of surfaces 106 of the polymer waste to a polar group donor 108 to effect reaction producing modified polymer. Polar group donors that are suitable include, for example and without limitation, sulfuric acid. Reaction of the polymer surface 106 in the example exposing the surface to sulfuric acid as the polar group donor, adds sulfate groups, produces sulfated polymer. Other examples polar donors include but are not limited to exposure to acetic acid to add COO—; and can include exposure to nitric acid to add nitrate groups.

In one or more embodiments the modification process 102 may be configured to continue the described reaction for a time interval that, for purposes of description, will be referenced herein by the alphanumeric “SVT.” The numeric value of SVT is basically the length of time sufficient to modify enough of the surface area of the separated waste polymer such that the low temperature plasma depolymerization 114 process described in the following paragraphs has satisfactory performance. Persons of ordinary skill in the relevant arts (POSITAs) will understand from reading this disclosure that preferable numeric value(s) of SVT may be in part application specific, but can determine the preferable value without undue experimentation. It will be understood that “SVT.” as used herein, is only an arbitrarily coined reference that has no intrinsic meaning.

As described above, the numeric value of SVT can be, at least in part, application specific. One example range of values of SVT can be about 10-100% of the plastic, such as about 10, 15, 20, 25, 30, 35, 40, 45, 50, 55, 60, 65, 70, 75, 80, 85, 90, 95 or 100%. Preferably, from 50 to 100% of the plastic is modified. The modification reaction can takes place for a time duration from about 1 hour to about 48 hours or longer, including any from among about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47 or 48 hours.

Referring to FIG. 1, in one or more embodiments a separation operation or step 110 can separate the solid modified polymer from the solvent stream produced by the modification process 102. In an example instance of the flow 100 operations can proceed from the separation step 110 to feeding the solid modified polymer to an oxidative depolymerization process 112.

According to one or more embodiments, operations in the oxidative depolymerization process 112 can comprise placing the modified polymer in a reaction vessel or chamber 114. The reaction vessel or chamber 114 can be, for example, a plasma or vacuum chamber. For purposes of description the reaction vessel or chamber 114 will be generically referenced as a “plasma chamber 114.” The plasma chamber 114 can include two or more electrodes, to generate an electric energy for particular plasma-based operation. Implementation of “includes” can be, for example, electrodes within the chamber, or positioned proximal to the chamber, or both.

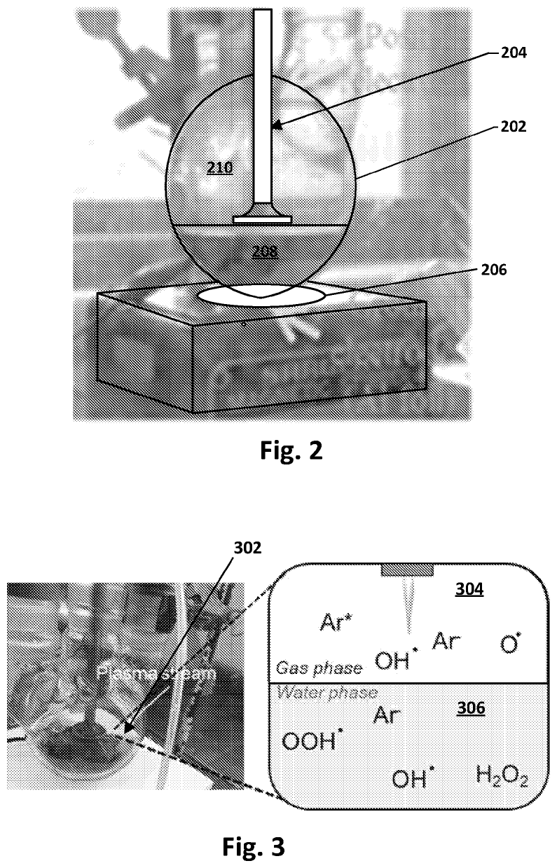

FIG. 2 shows an image of one example plasma chamber 202 and having, in an arrangement in which a positive electrode such as the example positive electrode 204 projects to a tip portion within the chamber body, and a negative electrode, such as the example negative electrode 206 is proximal to the chamber. The negative electrode 206 can comprise, for example and without limitation, aluminum or other metal body, e.g., foil.

In operation, the plasma chamber 202 can carry a liquid (e.g., water) phase 208 and a gas phase 210 to initiate oxidative depolymerization reactions in accordance with one or more embodiments.

FIG. 3 shows the FIG. 2 example plasma chamber in an operation using argon as a fill gas, juxtaposed with a graphic model of a resulting gas phase-liquid phase interface. As visible, in this example operation the a plasma stream 302 is generated, and the gas phase 304 comprises O and OH within argon ions, and the water phase includes OOH.

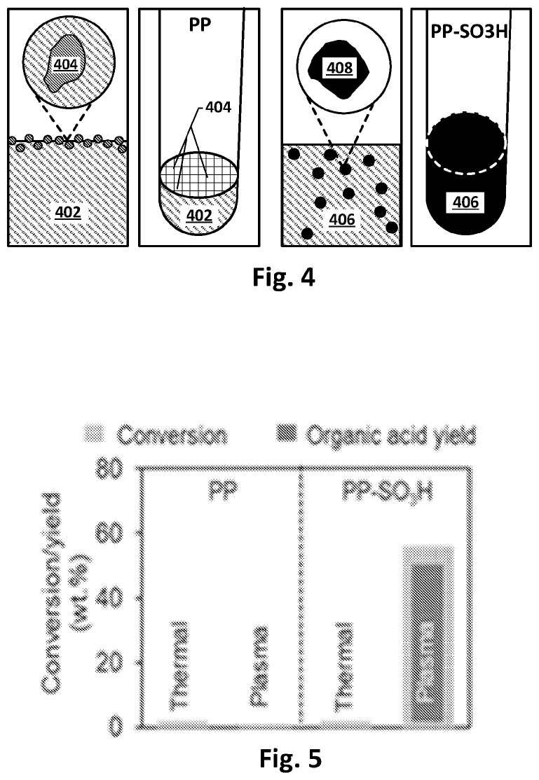

FIG. 4 shows synergy between functionalization and plasma oxidation of polypropylene (PP), and PP-SO3H being hydrophilic.

FIG. 5 shows synergy between polymer functionalization and plasma oxidation using a thermal condition of 60° C., and plasma generated by 5 kV input voltage at 20-50 kHz, for 4 hours, using UiO-66 catalysts. This enabled the formation of 43.5 wt. % organic acids at 50 wt. % conversion.

In such operations the plasma chamber 114 can contain, according to one or more embodiments, at least two phases (a gas phase and a liquid phase). According to one or more embodiments, the plasma chamber 114 can include one or more catalyst.

Regarding structure of the plasma chamber 114, the chamber can be formed of a non-reactive material such as stainless steel or high-purity silica glass, and is constructed to withstand high pressure.

Regarding the catalyst in the plasma chamber 114, the catalyst can comprise, for example and without limitation, metal-organic frameworks (MOFs). MOFs are effective catalysts for polymer oxidation. MOFs are porous solids and constructed by linking metal nodes with organic linkers. MOFS have a high metal concentration by weight, high surface area, and porosity, making them excellent catalytic materials. The presence of the metal nodes gives MOFs catalytic activity, especially for oxidation reactions. According to various embodiments, metal nodes of MOFs can decompose H₂O₂ into OH radicals, which are potent oxidizing agents for degradation of pollutants.

According to various embodiments, defects in the form of open-metal sites can be created in situ by exposure to the plasma during the plasma oxidation reaction. This in-situ generated open-metal sites in the MOF catalyst can assist in the oxidation reaction. In practices using MOF as the catalyst, the MOF can be, for example, UiO-66 (Zr) catalyst, which can provide thermochemical stability and ability to decompose H₂O₂ to OH radicals.

According to various embodiments, the depolymerization process 112 can comprise generating in the plasma chamber 114 of artificial plasmas by applying electric and/or magnetic fields through a gas. Therefore, prior to such generation of the plasma, the air within the plasma chamber 114 can be removed/pumped out and the chamber 114 filled with a suitable gas. The gas phase can be, for example and without limitation, an inert gas such as argon.

### Non-Limiting Example Types of Plastics

A wide variety of plastic waste types can be treated using the methods disclosed herein. Examples include but are not limited to #1-PET (polyethylene terephthalate); #2-HDPE (high-density polyethylene); #3-PVC (polyvinyl chloride); #4-LDPE (low-density polyethylene); #5-PP (polypropylene); #6-PS (polystyrene); #7, miscellaneous polycarbonate. In particular, plastics that can be processed include but are not limited to polypropylene, polyethylene, polyvinylchloride, and polyethylene terephthalate.

Sources of recyclable plastics are well known in the art, as are various processes for mechanically pretreating the recyclable plastics for further processing, such as shredding, pulverizing, forming into pellets or powder, etc.

### Production of Medium Chain Length C6-C14

### Poly Hydroxyl-Alkanoates (MCL-PHAs)

In practices according to various embodiments, short chain organic acids produced by the plasma reaction may be removed from the aqueous phase of the plasma chamber, and then used in a production mcl-PHAs, for example via a fermentation process. In one or more embodiments, the short chain can be further treated prior to the fermentation. For example, the short chain organic acids may be concentrated, filtered, subjected to size chromatography.

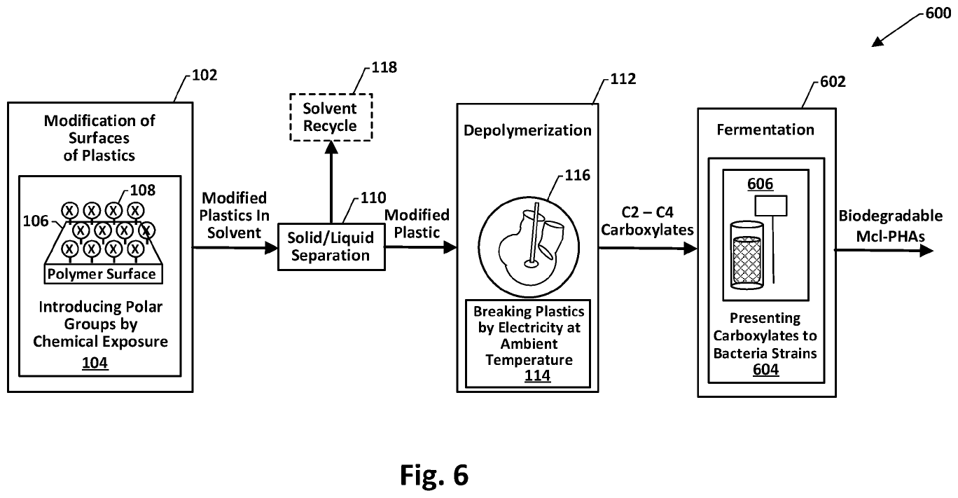

FIG. 6 shows a block schematic of one example flow 600 of operations in one example process according to one or more other embodiments, utilizing the low heat, low power transformation of organic polymer waste to ROS, combined with biological transformation according to one or more embodiments of the ROS into mcl-PHAs.

Example parameters for practices according to the process 600 are described in more detail in the Examples section later in this description show the production of 48.5 g of carboxylates per 100 g of polypropylene under 5 kV electrical discharge in liquid water at room temperature. Moreover, the resulting carboxylates were compatible with fermentation by P. putida and gave 2.7 g mcl-PHAs/L (0.06 g mcl-PHAs/g carboxylates consumed).

FIGS. 7A, 7B, and 7C show three temporally spaced snapshots of a first magnification of a transmission electron microscopy (TEM) captured image of accumulation of PHAs (medium chain length polyhydroxyalkanoates, C6-C14) in the P. putida KT2440 (bright granules=PHAs).

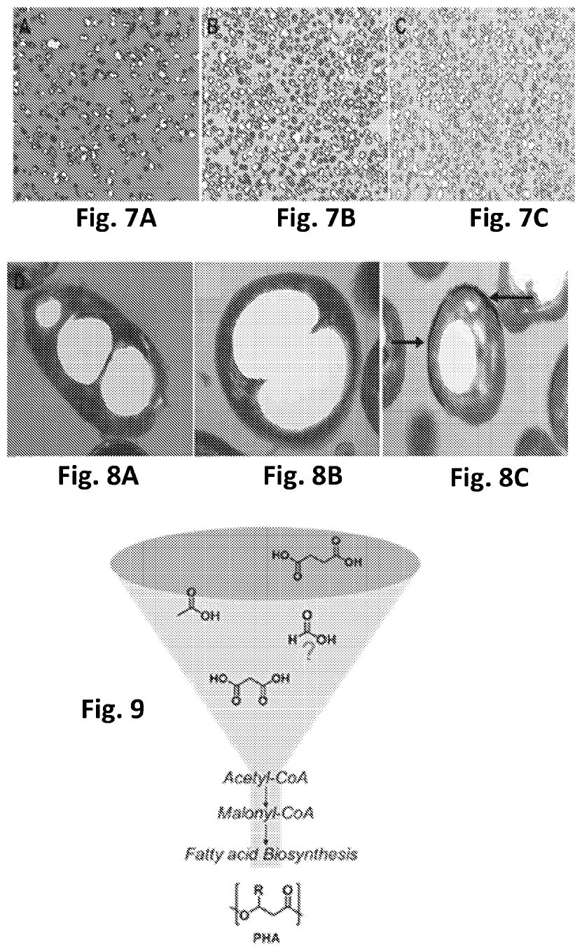

FIGS. 8A, 8B, and 8C show three temporally spaced snapshots of a second magnification TEM captured image of the accumulation of PHAs in the P. putida KT2440. FIG. 9 shows a diagrammatic model of metabolic pathways of selected organic acids by P. putida.

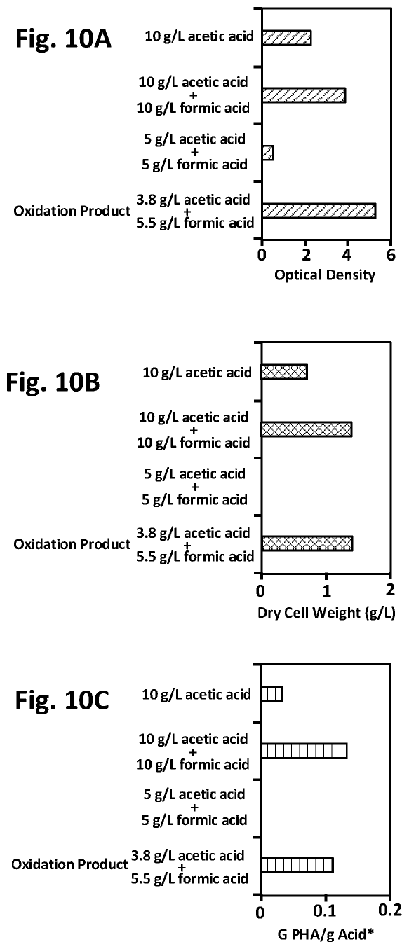

FIGS. 10A, 10B, and 10C show composition of acid mixture affects cell growth and PHA yield. The data collection for FIGS. 10A, 10B, and 10C used the following fermentation conditions. Ten percent P. putida KT2440 seed culture (active cells) in minimal medium plus (NH4)2SO4 can provide necessary N. The result was stirred at 200 rpm at 30° C. for 3 days.

Pseudomonas species have a well-known presence in microbial communities that degrade complex hydrocarbons in oil spills, wastelands and sewage. P. putida in particular is a nonpathogenic, GRAS (generally-regarded-as-safe), Gram-negative soil bacterium that thrives in contaminated industrial pollutant sites. Apart from their ability to metabolize sugars, organic acids, polyols and aromatics, some Pseudomonas species can also catabolize polyethylene and poly urethane-derived plastics. Interestingly, unlike many other microbial hosts, glucose is not the preferred carbon source of P. putida. Instead, succinic acid and other citric acid cycle intermediates (C₄-C₆ acids) are the preferred substrates. These growth characteristics make P. putida an example of a preferred host to consume oxidized plastic monomers generated by plasma oxidation, as described herein to produce mcl-PHAs.

Carbon flux in P. putida is diverted to fatty acid synthesis, and distinctly, one of the primary products that the cells accumulate is mcl-PHAs (medium chain length polyhydroxyalkanoates, C6-C14; FIG. 3A-F), which comprises 75% (v/v) of mcl-PHAs. PHAs are bacterial storage compounds, biodegradable polyesters that are considered as a lucrative eco-friendly alternative to petroleum-derived plastic polymers. Based upon their alkyl side chain length, PHAs deliver different material properties that can eventually be a replacement to petroleum-derived polyethylene, polystyrene, and polyethylene terephthalate. PHA yield is reported to reach ˜40% from glucose as the substrate. Thus, the process provides feeding plasma oxidation products to P. putida strains which leverages the natural ability of the bacterium to accumulate mcl-PHAs.

Metabolic pathways of selected organic acids by P. putida are shown in FIG. 9.

Examples of Pseudomonas species/strains which can be utilized to consume and metabolize the oxidized plastic monomers include but are not limited to: P. putida KT2440, P. fluorescens 555.

Those of skill in the art are familiar with conditions that are suitable for bacterial growth. For example, a suitable medium is provided and a seed culture is disposed therein under conditions that permit the bacteria to grow, metabolize and reproduce. Often bacteria are cultured e.g., at about 37° C. for a period of time ranging from about 1-24 hours or longer, such as about 1, 2, 4, 6, 8, 10, 12, 14, 16, 18, 20, 22, or 24 hours or longer, such as for about 1, 2 or 3 days. Generally growth is allowed to proceed past the logarithmic phase and is stopped at some point during stationary phase.

After a suitable period of bacterial growth, the bacterial cells can be harvested, broken open and the mcl-PHAs can be harvested from the medium using stand-alone tools, such as centrifugation, filtration, etc. In accordance with one or more embodiments, mcl-PHAs may be further processed, e.g., by washing, drying, by solvent exchange, etc. as described in the Examples section below.

### Methods for PHA Extraction and Quantification.

Lyophilize harvested bacterial cells. PHAs were extracted by chloroform. One milliliter of chloroform was added to 5-20 mg of lyophilized cells, followed by addition of 0.85 ml methanol and 0.15 ml concentrated sulfuric acid (95%). The mixture was heated at 100° C. for 2.5 h. Afterward, the slurry was cooled to room temperature and then 0.5 ml of water was added to the samples (on ice). The slurry was centrifuged at 2,000 rpm for 5 min. Subsequently, the organic phase, containing the produced PHAs, was removed, transferred to a new tube, and dried with 200 mg of anhydrous Na2SO4. Then the resulting samples were analyzed by gas chromatography-mass spectrometry (GCMS) to identify and quantify the concentration of monomers (C4-C14).

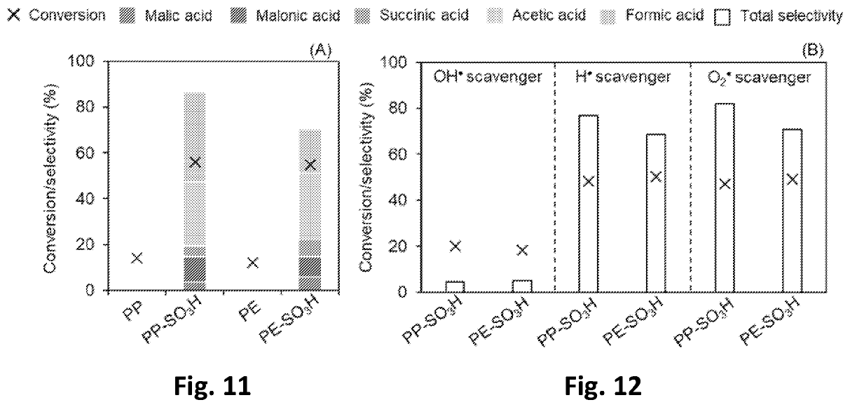

FIG. 11 shows a plasma-mediated oxidative depolymerization of sulfonated polypropylene and polyethylene.

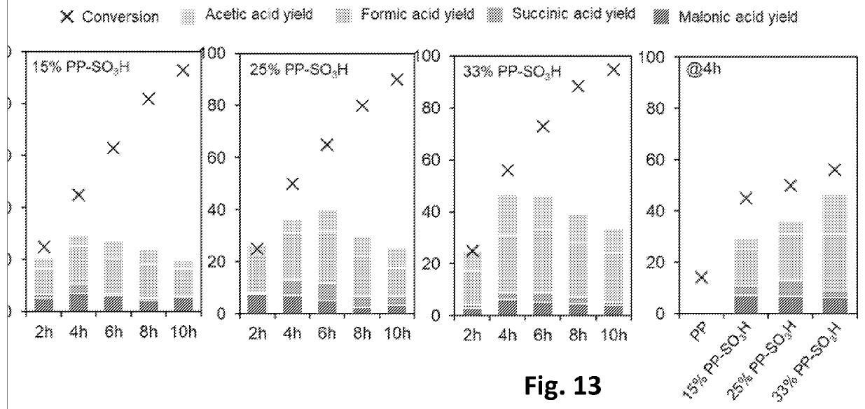

FIG. 12 shows effects of radical species on plasma-mediated oxidative depolymerization of sulfonated polypropylene and polyethylene, using terephthalic acid (TPA) as a OH· scavenger, CCl4 as a H· scavenger, 1,4-benzoquinone as a O2· scavenger. Reaction condition: 1 g feed, 10 wt. % UiO-66, 25 mL water, Argon flow (30 cc/min), 5 kV, 24 kHz, 4 h.

FIG. 13 shows plasma-mediated depolymerization of modified polypropylene (PP-SO3H).

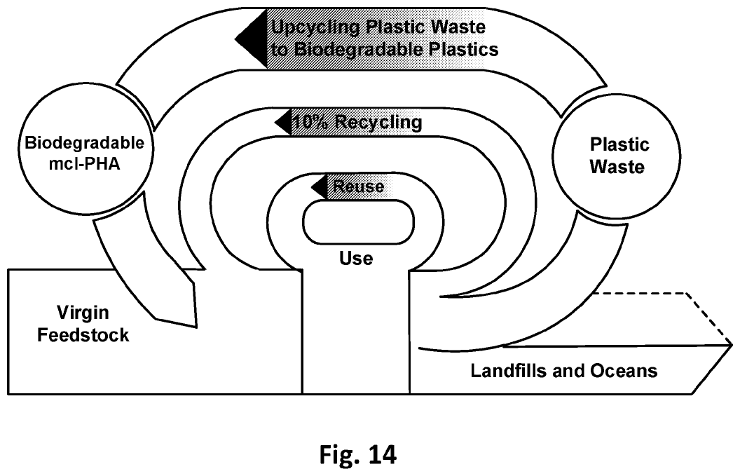

FIG. 14 shows an analysis based indication of potential increase in recycling rates and potential decrease in the amount of plastic added to landfilled that may result from analysis based incentives provided by one or more embodiments.

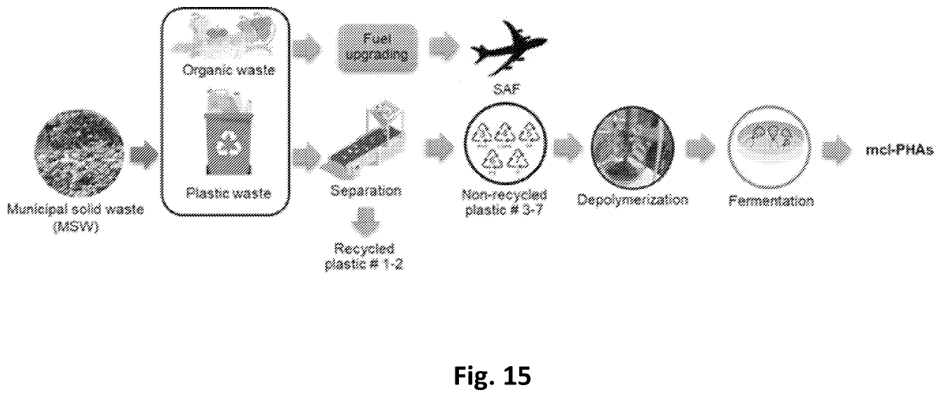

FIG. 15 shows a flow diagram of one example process in accordance with various embodiments for converting non-limiting examples of plastics often characterized as non-recyclable #3-7 into mcl-PHAs.

As a control, the oxidation of unmodified PP and PE had 14 and 22 wt. % conversion respectively with no carboxylate products yield after 4 hours. The reaction of modified polypropylene (PP-SO3H) yielded 48 wt. % carboxylates at 56 wt. % conversion. Formate was a major product with 22% yield, followed by 16% acetate, 6% malonate, 3% succinate, and 2% malonate. On the other hand, the oxidation of modified polyethylene (PE-SO3H) yielded 39 wt. % carboxylates at 55 wt. % polyethylene conversion after 4 h. Acetic acid was a major product with 15% yield, followed by 11% formate, 5% malonate, 4% succinate and 3% malate.

To decouple the effect of applied Ar plasma and metal oxide catalysts (ZrO2, CuO, Fe2O3, metal-organic frameworks), we performed similar experiments using PE-SO3H without applied Ar plasma or catalyst. Without applied Ar plasma or added UiO-66 (Zr), we observed a low conversion of PE-SO3H with a trace of acetate and formate product. Together, these results suggested that polymer sulfonation, applied Ar plasma, and UiO-66 (Zr) catalyst, enhanced reactivity of plasma oxidation and facilitated oxidative depolymerization into carboxylates by catalytic nonthermal plasma.

Identification of the active radicals for catalytic nonthermal plasma. To identify the radical species responsible for oxidative depolymerization, we performed oxidative depolymerization experiments of PP-SO3H and PE-SO3H. We added three radical scavengers, terephthalic acid (TPA), CCl4, and 1,4-benzoquinone to trap OH·, H·, and O2-·, respectively. With added CCl4 and 1,4-benzoquinone, we observed similar carboxylate yield similar to the oxidative depolymerization of polyethylene without CCl4 and 1,4-benzoquinone. These results suggested that H· and O2-· did not have any effect on the depolymerization of modified PP and PE. We observed no carboxylate yields with added TPA, which suggested that OH· was responsible for the C═C bond cleavage of modified polyethylene.

Interestingly, the carboxylate yield from the oxidative depolymerization of modified polyethylene started to decrease after 4 h. To elucidate the cause for the reduction of carboxylate yield, we made a solution with a known carboxylate concentration. Then, we applied plasma to the solution of carboxylate with known concentration and added three radical scavengers, terephthalic acid (TPA), CCl4, and 1,4-benzoquinone, to trap OH·, H·, and O2-·, respectively. We found the carboxylate yield decreased for every scavenger.

We found that adding TPA reduced carboxylate degradation, which showed the OH· radical as the most active radicals for the carboxylate degradation and the degradation rate was in the following order: no scavengers>OH·>O2-·>H·.

The present methods can be performed under mild reaction conditions. For example, processes according to various embodiments can be practiced within a temperature range such as from about 15-25° C., including about 15, 16, 17, 18, 19, 20, 21, 22, 23, 24, or 25° C. (including all decimal fractions in between to 0.1 degree). In one more embodiments, the temperature range can be about 18-22° C. In such embodiments and in one or more further embodiments, the temperature can be about 20° C., which is typically understood to represent “room temperature”.

In the described plasma based depolymerization, electrical discharge through the gas created a plasma by accelerating free electrons in the gas thereby forming excited species. The electric discharge can use an electric field having a magnitude of, for example, from about 1-10 kV, including any among about 1, 2, 3, 4, 5, 6, 7, 8, 9, or 10 kV. An example field can be 5 kV.

In practices according to one or more embodiments an excited plasma species can interact with water molecules in a manner generating reactive oxygen species (ROS), such as hydroxyl radicals (OH·), superoxide (O₂⁻), and H₂O₂. These ROS species can initiate oxidative depolymerization reactions of the polymers. The reaction is a decarboxylation reaction which breaks C—C covalent bonds and generates short chain organic acids, for example, C2-C6 organic acids.

### Illustrative Examples of Products

Mcl-PHAs are biodegradable plastics that can replace petroleum-derived polypropylene and other plastic precursors. The market for PHAs is projected to be $121M by 2025 due to (1) increased demand for use in food packaging, medicine, and agriculture, (2) awareness of the negative environmental impacts and toxicity of petroleum-derived plastics, and (3) current global price volatility of fossil fuels. Therefore, the described techniques' capability to convert plastics to mcl-PHAs enables, and through the techniques' further advantages such as lower temperature requirements, can provide economic incentives for practicing the techniques, for example to plastic manufacturers, the waste management industry, and the recycling industry.

Mcl-PHAs can serve as replacements for petroleum-derived polyethylene (PE), polypropylene (PP), polystyrene (PS), and polyethylene terephthalate (PET) in manufacturing.

Many products can be made using the mcl-PHAs produced through practices according to the described techniques. Both the products and the manufacture of such products can carry and can provide various benefits. Examples include, without limitation, mcl-PHAs being nontoxic and being particularly biocompatible. The latter enables mcl-PHA based products be used in biomedical applications such as to manufacture implants, sutures, scaffolds, and drug delivery carriers. However, non-medical uses are also encompassed, e.g., the manufacture of bottles, bags, containers, packaging, fibers, fabric, clothing, furniture, appliances, computers, TVs and radio, etc. Any product that was previously made using PE, PP. PS, and PET can be manufactured using mcl-PHAs made as disclosed herein.

Where a range of values is provided, it is understood that each intervening value, to the tenth of the unit of the lower limit is encompassed unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Reading this description will be with the understanding that a word appearing in the singular encompasses its plural counterpart, and a word appearing in the plural encompasses its singular counterpart, unless implicitly or explicitly understood or stated otherwise. Also, it will be understood that for any given component or embodiment described herein, any of the possible candidates or alternatives listed for that component may generally be used individually or in combination with one another, unless implicitly or explicitly understood or stated otherwise. Moreover, it will be understood that the figures, as shown herein, are not necessarily drawn to scale, and some of the example components and implementations of elements may be drawn to a scale selected for purposes of clarity. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations. Persons of ordinary skill will appreciate, for example, that values of the parameters can vary depending upon, for example, application-specific selection and prioritization of properties. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, statistically contain error quantities necessarily resulting from the standard deviation found in their respective testing measurements.

The following examples are included to further assist persons of ordinary skill in understanding and thus practicing in accordance with described techniques. The examples can assist such persons in seeing different factors and considerations in selecting, for example, parameters and preferences in practicing of the embodiments. It should be appreciated by those of skill in the art that the techniques disclosed in the examples which follow represent techniques discovered by us to function well in practices according to disclosed embodiments and thus can be considered to constitute preferred modes for such practice, at least in certain environments and applications. However, those of skill in the art should, in light of the present disclosure, appreciate that many changes can be made to specific embodiments that are disclosed, while still obtaining a like or similar result without departing from the spirit and scope of this disclosure.

All patents and publications mentioned in the specification are indicative of the level of those skilled in the art to which this disclosure pertains. All patents and publications are herein incorporated by reference in their entirety to the same extent as if each individual publication was specifically and individually indicated to be incorporated by reference.

### FURTHER EXEMPLARY FEATURES AND ASPECTS

We introduced polar functional groups on the polymer surface weaken C—C bond energy. Our quantum calculations, using a model linear C9-alkane polymer, indicate bond dissociation energy of C—C bonds decreased in the functionalization order —OH>—SO₃H>—NH₂.

### Embodiments can Provide Oxidative Depolymerization in Liquid Water

We chemically modified polypropylene with —SO₃H. The resulting modified polymer (PP-SO₃H) was more hydrophilic, which enabled the oxidative depolymerization in liquid water.

Usable Synergy between Polymer Modification and Plasma Depolymerization Next, to determine the effect of plasma on the polymer depolymerization, we performed oxidative depolymerization of functionalized polypropylene using UiO-66 catalysts under plasma at 5 kV with Ar flow (30 cc/min) to generate the discharge. We chose UiO-66 catalysts because of their chemical stability and ability to decompose H₂O₂ to OH radicals. We used a simple plasma discharge setup.

We did not observe oxidation activity nor OH radicals under thermal conditions (60° C.). Conversely, plasma oxidation of functionalized polypropylene yielded 43.5 wt. % yields of organic acids at 50 wt. % conversion. These results indicated a synergy between functionalization and plasma oxidation that facilitated the polymer depolymerization.

Polymer Plasma Depolymerization Products for Production of Mcl-PHAs by P. putida.

Example Configurations, Materials, and Various Parameters for Practices in Accordance with One or More Embodiments

Fermentation conditions: Ten percent P. putida KT2440 seed culture (active cells) in minimal medium plus (NH₄)₂SO₄ was used to provide necessary N. The culture was stirred at 200 rpm at 30° C. for 3 days. Method for PHA extraction and quantification. Lyophilize harvested bacterial cells. PHAs were extracted by chloroform. One milliliter of chloroform added to 5-20 mg of lyophilized cells, followed by addition of 0.85 ml methanol and 0.15 ml concentrated sulfuric acid (95%). The mixture was heated at 100° C. for 2.5 h. Afterward, the slurry was cooled to room temperature and then 0.5 ml of water was added to the samples (on ice). The slurry was centrifuged at 2,000 rpm for 5 min. Subsequently, the organic phase, containing the produced PHAs, was removed, transferred to a new tube, and dried with 200 mg of anhydrous Na₂SO₄. Then the resulting samples were analyzed by gas chromatography-mass spectrometry (GC-MS) to identify and quantify the concentration of monomers (C4-C14).

### Composition of Acid Mixture Affects Cell Growth and PHA Yield

Metabolism of selected organic acids (acetate, propionate, and butyrate) by P. putida is known. On our belief, producing organic acids from plasma oxidation of plastics and other organic polymers is novel. Our verifications include presenting oxidation products of PP-SO3H that contained 3.8 g/L acetic acid and 5.5 g/L formic acid. to P. putida and harvesting the cells after three days. We observed that P. putida grew well in the plasma oxidation products of said PP-SO3H that contained 3.8 g/L acetic acid and 5.5 g/L formic acid. We observed that the cells gave a 2.3 OD and 0.1 g PHA/g acids. In addition, P. putida grew well in 10 g/L acetic acid+5 g/L formic acid (OD 3.9). However, it did not grow with a formic acid concentration of 10 g/L. These results demonstrated that the composition of the acid mixture affects cell growth and PHA production by P. putida.

Processes according to various embodiments, and methods and systems comprising such processes can provide, among other features and benefits, a plasma discharge and biological transformation that has multiple significant improvements over pyrolysis. One indicator of the magnitude of the improvements is effectively overcoming the barrier of plastic inertness at low temperature. This has an array of further benefits. For example, it enables upcycling of plastic waste (especially plastic waste #s 3-7 which are typically not recyclable) to polyesters at low temperatures. This has still further benefits such as, without limitation, not merely reducing plastic waste and thus preventing it seeping from landfills to pollute water and soil, but transforming the waste into valuable material.

The societal impacts include a novel plasma plastics upcycling technology that produces biodegradable polymers and best practice guides for implementing recycling programs at the community level. The developed plastic upcycling process is energy-efficient, and it can be powered by electricity from renewable wind and solar. The process is an important platform to decrease the plastic waste in landfills and ecosystems and transition society toward a circular economy of plastics. Plasma oxidation technology is applicable to all plastic types and can be extended to upcycling waste tires and toxic organic pollutants in wastewater. All these activities can promote a circular economy of plastics and increase the recycling rates of plastics.

The chemical-biological process converts plastics (#1-7) to medium-chain-length polyhydroxyalkanoates (mcl-PHAs), biodegradable plastics. Plastics are not typically recycled because of the lack of market and because most chemical plastic depolymerization approaches convert only a single plastic type into small molecules for subsequent bacterial fermentation into mcl-PHAs. The present methods provide for production of biodegradable mcl-PHAs that can replace petroleum-derived plastics, thereby creating a circular economy, and feedstock-independence. An additional benefit is that this technology uses renewable electricity from wind and solar to drive plastics depolymerization reactions, thereby minimizing the greenhouse gas emission from burning fossil fuels to provide heat.

Presently, inconsistent local policies/practices about plastic recycling lead to uncontrolled amassing of plastic waste. and methods according to various embodiments make available a practical, readily implemented, energy efficient, environmentally friendly plasma catalysis process. This can benefit industry, dispels consumer reluctance to recycle plastic, and ultimately decreases the accumulation of plastic in landfills and oceans.

Such benefits include, but ac not limited to:
Feedstocks—Waste polymers, low-density polyethylene (LDPE), polypropylene (PP), polyvinylchloride (PVC), polystyrene (PS), and rubber tires (polystyrene-butadiene), are typically consigned to landfills where they become air and water pollutants. Our technology diverts these waste polymers to chemical feedstocks.
Products—Production of organic acids (oxalic acid, formic acid, acetic acid, maleic acid, malic acid, succinic acid) and medium-chain-length polyhydroxyalkanoates (mcl-PHAs) reduces reliance on petroleum for the production of conventional chemicals and petroleum-derived polymers (plastics and rubber tires)
Ambient Depolymerization—The developed ambient depolymerization technology functions at ambient conditions using electrical discharge, thereby saving energy costs. Moreover, the electricity can be sourced from low-carbon renewable resources (wind and solar), thereby minimizing the operating cost and GHG emissions compared with the production of petroleum-derived polymers (plastics).

We have optimized the amount of functional groups on the surface of plastics. We found that an increase in the amount of functional groups enhanced the degree of hydrophilicity of the modified polypropylene.

We subjected the modified polypropylene through plasma-mediated depolymerization. We found that the high amount of functional groups led to an increase in the yield of desired products (organic acids).

We fed the depolymerization products from plasma-mediated depolymerization of modified polypropylene (PP-SO3H) and polyethylene (PE-SO3H) using bacteria. We obtained medium-chain-length polyhydroxyalkanoates (mcl-PHAs), valuable bioplastics as shown in Table 1 below:

TABLE 1

| | PHA | Acid consumed | PHA yield |
|---|---|---|---|
| | (g/L) | (g/L) | (g/g) |
| Control (Acetic 6 g/L, Formic | 0.36 | 9.6 | 0.037 |
| 3.5 g/L, Malate 2 g/L) | | | |
| PP-SO₃H | 0.42 | 6.6 | 0.064 |
| PE-SO₃H | 0.38 | 9.5 | 0.040 |

While techniques have been described in terms of exemplary preferred embodiments, those skilled in the art will recognize from the description that these techniques and various adaptations and modifications thereof can be practiced using, for example, implementations comprising various alternative configurations and arrangements, and alternative architectures that are within the spirit and scope of the appended claims. Accordingly, practices of disclosed techniques are not limited to the embodiments as described above but instead further include all modifications, adaptations, and equivalents thereof within the spirit and scope of the description provided herein.

We claim:

1. A method for transforming organic polymer waste, comprising:
chemically functionalizing waste pieces of organic polymer, having respective surfaces, into pieces of sulfonated organic polymer having respective sulfonated polymer surfaces, one or more of the sulfonated polymer surfaces supporting sulfonate moieties; and
oxidatively depolymerizing one or more of the pieces of sulfonated organic polymer, in an electric field, into a depolymerization product comprising a plurality of acids.

2. The method of claim 1 wherein the electric field has a field strength less than 25 kV per meter and is an oscillating electric field, wherein the oscillating is less than 100 kHz.

3. The method of claim 1 wherein at least a portion of the energy required to produce the electric field is provided by one or more renewable energy sources.

4. The method of claim 1 wherein the oxidatively depolymerizing step is performed in the presence of a metal organic framework.

5. The method of claim 4 wherein the metal organic framework includes Ui66.

6. The method of claim 1 wherein during oxidatively depolymerizing the sulfonated plastic is present in an aqueous environment.

7. The method of claim 6 wherein the aqueous environment includes one or more hydrogen scavengers, and/or one or more hydroxy scavengers, and/or one or more oxygen scavengers.

8. The method of claim 1 wherein the waste polymer comprises polypropylene and/or polyethylene and/or polyvinylchloride and/or polyethylene terephthalate.

9. The method of claim 1 further comprising a fermenting of the depolymerization product into medium-chain-length polyhydroxyalkanoates (mcl-PHAs).

10. The method of claim 9 wherein the polyhydroxyalkanoates include one or more monomers selected from the group consisting of 3-hydroxy hexanoate, 3-hydroxy octanoate, 3-hydroxy decanoate, and 3-hydroxydodecanoate.

11. The method of claim 9 wherein the fermenting uses a P. putida species, performed within an aqueous environment.

12. The method of claim 9 further comprising production of an organic acid, wherein the organic acid comprises formic acid, and/or acetic acid, and/or succinic acid, and/or malonic acid, and/or malic acid.
